(19) United States
(12) Patent Application Publication
(10) Pub. No.: US 2025/0385725 A1
(43) Pub. Date: Dec. 18, 2025

(54) FREQUENCY TRANSLATING REPEATER

(71) Applicant: QUALCOMM Incorporated, San Diego, CA (US)

(72) Inventors: Sourjya DUTTA, San Diego, CA (US); Navid ABEDINI, Basking Ridge, NJ (US); Kapil GULATI, Belle Mead, NJ (US)

(21) Appl. No.: 18/745,793

(22) Filed: Jun. 17, 2024

(51) Int. Cl. H04B 7/155; H04W 72/0453; H04W 72/56

(52) U.S. Cl. CPC H04B 7/15528; H04W 72/0453; H04W 72/56

(57) ABSTRACT

Certain aspects of the present disclosure provide techniques for wireless communications via a frequency translating repeater. An example method for wireless communications by an apparatus includes obtaining a first configuration that indicates one or more first backhaul link transmission opportunities for translating one or more signals from a first frequency spectrum to a second frequency spectrum, wherein the first frequency spectrum is different from the second frequency spectrum; and sending a first signal to one or more network entities via the second frequency spectrum based on a second signal from one or more user equipment (UEs) via the first frequency spectrum.

### INTRODUCTION

### Field of the Disclosure

Aspects of the present disclosure relate to wireless communications, and more particularly, to techniques for communications via a repeater.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes obtaining a first configuration that indicates one or more first backhaul link transmission opportunities for translating one or more signals from a first frequency spectrum to a second frequency spectrum, wherein the first frequency spectrum is different from the second frequency spectrum; and sending a first signal to one or more network entities via the second frequency spectrum based on a second signal from one or more user equipment (UEs) via the first frequency spectrum.

Another aspect provides a method for wireless communications by an apparatus. The method includes sending a first configuration that indicates one or more first backhaul link transmission opportunities for translating one or more signals from a first frequency spectrum to a second frequency spectrum, wherein the first frequency spectrum is different from the second frequency spectrum; and obtaining a first signal via the second frequency spectrum.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example wireless communications system where a network controlled repeater (NCR) forwards wireless communications between a UE and a network entity.

FIG. 6A depicts an example NCR that performs frequency translation.

FIG. 6B depicts an example NCR that performs frequency translation with digital signal processing.

FIG. 7A depicts an example wireless communications system where an NCR performs frequency translation between a first frequency spectrum and a second frequency spectrum.

FIG. 7B depicts an example wireless communications system where an NCR is arranged in a coverage area of a network entity.

FIG. 8 depicts an example of uplink grant management for forwarding traffic via an NCR from multiple UEs.

FIG. 9 depicts an example of NCR behavior when no uplink transmission is detected on the access link.

FIG. 10 depicts a process flow for signaling for wireless communications via frequency translating repeater.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for wireless communications via a frequency translating repeater.

Certain wireless communications systems (e.g., 5G New Radio (NR) systems and/or any future wireless communications systems) may use a radio frequency (RF) repeater to amplify RF signals communicated between devices, such as a user equipment (UE) and a network entity (e.g., a base station). As an example, the repeater may obtain an RF signal from a UE and output the RF signal at boosted power level to the network entity, or vice versa. The repeater may forward communication signals between the UE and network entity. In some cases, the repeater may extend the range of communications between the UE and the network entity. In certain cases, the repeater may be used to enable communications by providing an alternative path for RF signal propagation (e.g., a non-line of sight path) when a direct path (e.g., a line of sight path) between the UE and the network entity encounters certain object(s) (e.g., a tree, structure, building, and/or the like) that may contribute to or increase the path loss of the RF signal propagating between the UE and the network entity. Accordingly, the RF repeater may enable signal amplifying and forwarding functionality in a wireless communications system.

In certain cases, a radio spectrum may be divided into non-overlapping frequency bands by a regulator agency (e.g., the Federal Communications Commission) to define which devices can access the respective frequency bands for wireless communications. As an example, the radio spectrum may be divided into an unlicensed spectrum (also referred to as a shared spectrum) and a licensed spectrum. Within the radio spectrum, access to some frequency bands (e.g., licensed bands) may be restricted to devices that have access via a license, for example, obtained from a regulatory agency, such as the FCC. Other frequency bands (e.g., unlicensed bands) may be accessed by any device although certain regulations and/or specifications may be applied to reduce interference among devices. Unlicensed spectrum refers to a part of the electromagnetic spectrum that can be accessed or shared by devices for non-exclusive usage, while licensed spectrum refers to another part of the electromagnetic spectrum that can be accessed exclusively by a licensee, such as a mobile network operator, or device(s) with permission (e.g., a subscription) from the licensee for independent usage. Contention-based channel access techniques may be used by devices to communicate via the unlicensed bands, such as carrier sense and/or listen-before-talk (LBT) procedures.

Technical problems for wireless communications via an RF repeater may include, for example, providing effective spectral diversity and/or channel usage for communications using the RF repeater. As described herein, the RF repeater may forward signals communicated between the UE and the network entity. In some cases, the signals may be forwarded without frequency translation. For example, the RF repeater may obtain a signal at a carrier frequency and output the signal at the same carrier frequency, for example, in a licensed band. In such cases, a network entity may allocate a non-trivial amount of time-frequency resources to the RF repeater for communicating the forwarded signal. In certain cases, the signal output at the transmitting device may interfere with the forwarded signal output at the RF repeater due to the same carrier frequencies being used at the transmitting device and the RF repeater.

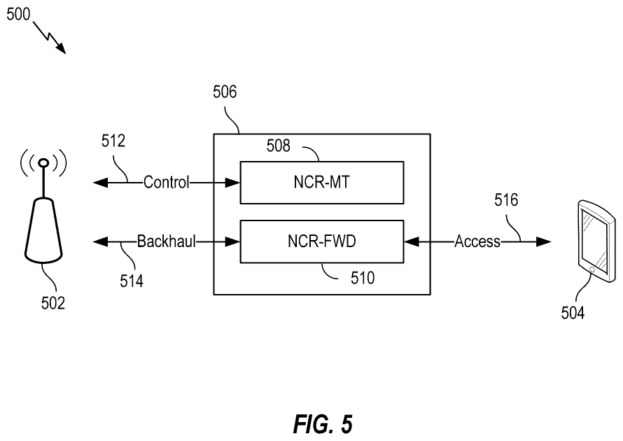

Aspects described herein may overcome the aforementioned technical problem(s), for example, by providing communications via a frequency translating repeater. A repeater (such as a network-controlled repeater (NCR) as further described herein with respect to FIGS. 5A and 5B) may forward signals between a UE and a network entity using frequency translation. The frequency translation may be from a licensed band or spectrum to an unlicensed band or spectrum. The repeater may be configured to translate communications from a first frequency spectrum (e.g., a licensed spectrum) to a second frequency spectrum (e.g., an unlicensed or shared spectrum), which may be different from the first frequency spectrum. In certain aspects, the repeater may forward uplink communications from a UE to a network entity, and the repeater may be configured with one or more uplink transmission opportunities to forward the uplink communications in the shared spectrum. In certain aspects, the transmission opportunities configured for the repeater may correspond to uplink transmission occasion(s) allocated for UE(s), such as semi-persistent or periodic uplink transmission occasion(s). As an example, the repeater may obtain a first signal from the UE in the first frequency spectrum and output a second signal to the network entity in the second frequency spectrum.

Certain techniques for frequency translation of forwarded communications described herein may provide various beneficial technical effects and/or advantages. The techniques for frequency translation of forwarded communications may enable improved wireless communications performance, such as frequency diversity and/or reduced channel usage of licensed band(s). The frequency diversity may be attributable to the frequency translation, for example, due to the forwarded signal being communicated in a different carrier frequency than the carrier frequency of the signal received at a repeater. The frequency diversity may enable the forwarded signal to be received at a network entity with improved signal quality and/or signal strength, for example, due to the frequency translation reducing or preventing the signal output at the UE from interfering with the forwarded signal. The reduced channel usage in licensed band(s) may be attributable to the frequency translation allowing the forwarded signal to be communicated in a shared spectrum without using additional time-frequency resources in licensed band(s) for the repetition of the transmission.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

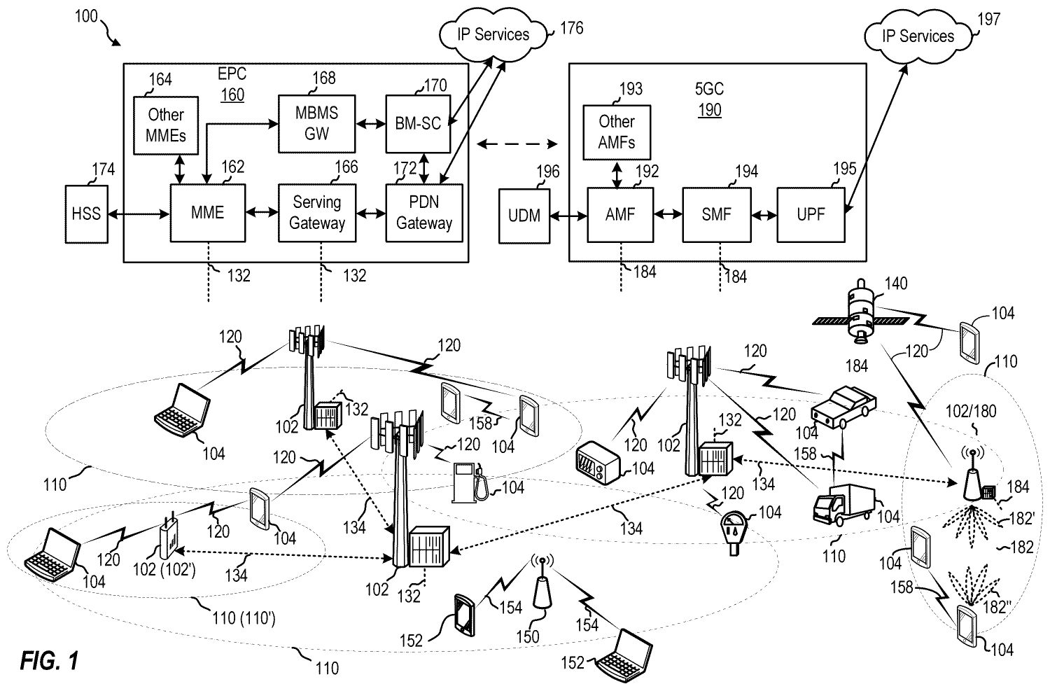

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

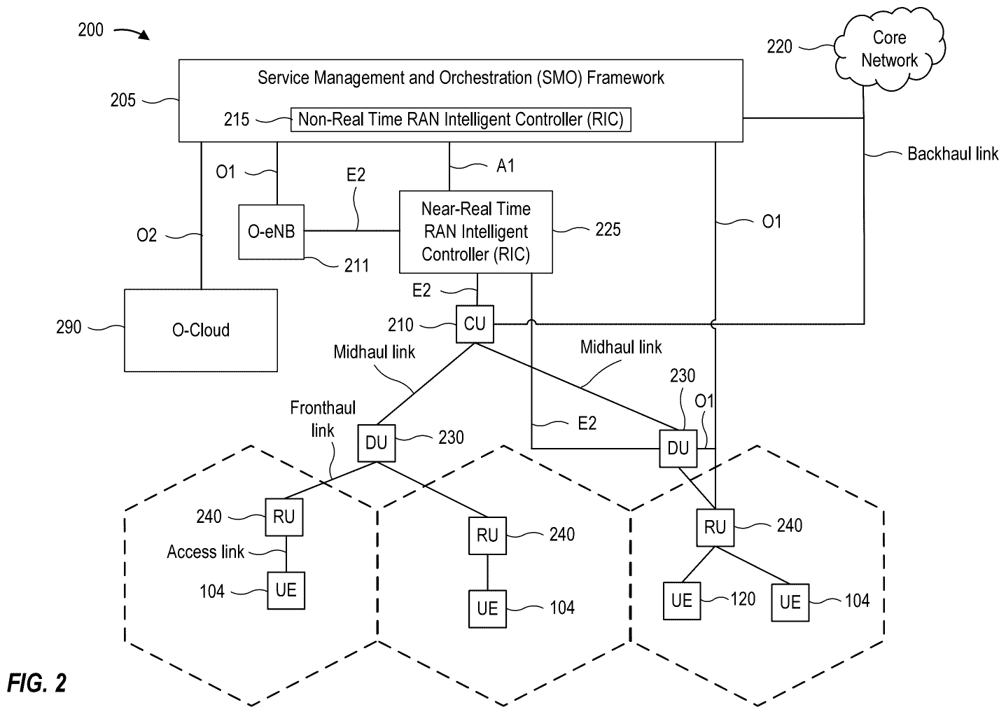

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

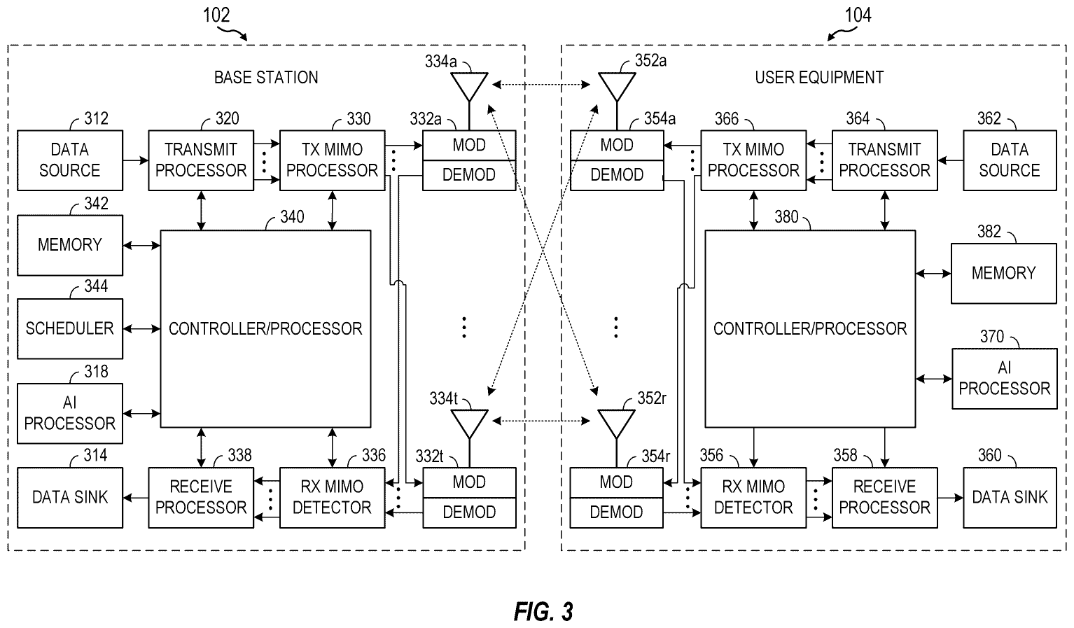

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

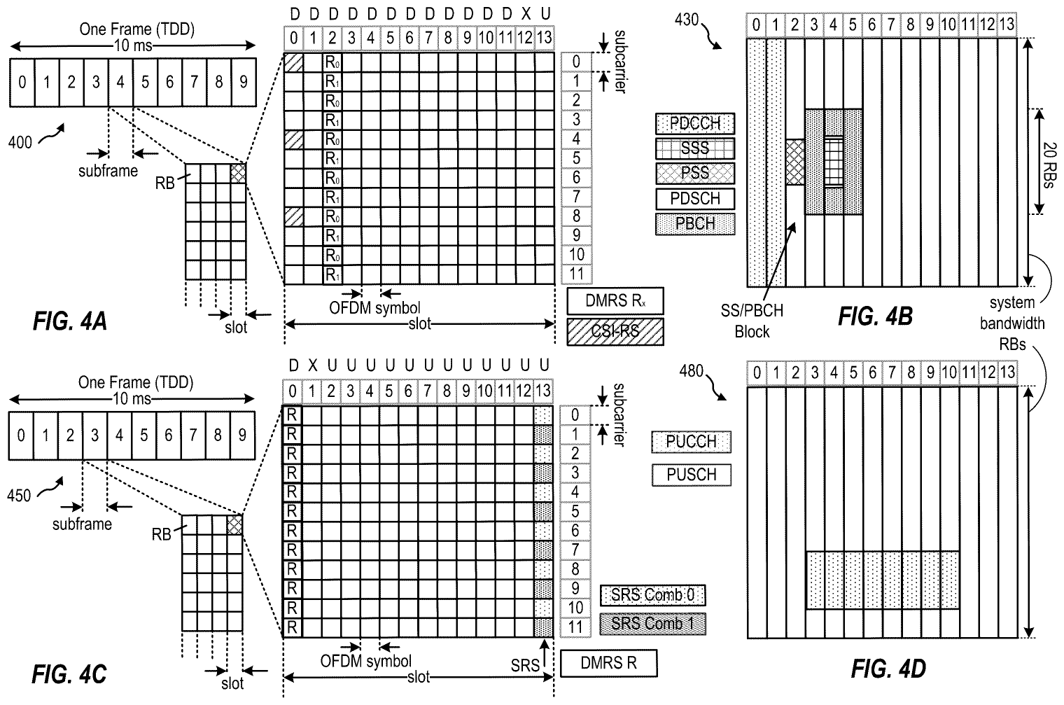

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology u, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Network Controlled Repeater

In certain cases, an RF repeater may be used to amplify and/or forward wireless communications between certain wireless communications devices, such as a UE and a network entity. A network-controlled repeater (NCR) is an example of an RF repeater that may be controlled by a network entity in certain wireless communications systems, such as 5G NR systems and/or any future wireless communications systems.

FIG. 5 depicts an example wireless communications system 500 where an NCR 506 forwards wireless communications between a UE 504 and a network entity 502. The NCR 506 may include a mobile termination entity (hereinafter “NCR-MT 508”) and a forwarding entity (hereinafter “NCR-FWD 510”). The NCR-MT 508 may support certain UE functionalities and communicate with the network entity 502 via a control link 512. The NCR-MT 508 may obtain, from the network entity 502, side control information via the control link 512 based on a Uu interface (e.g., the radio interface between the network entity and a UE). For example, the NCR-MT 508 may perform cell search, system information acquisition, random access procedure(s), uplink control information (UCI) reporting, PDCCH monitoring, PDSCH reception, CSI-RS measurements and CSI determination, PUSCH transmission, and/or SRS transmission via the control link 512.

The NCR-FWD 510 may amplify and/or forward signals between the network entity 502 and the UE 504 via a backhaul link 514 and an access link 516. The NCR-FWD 510 may communicate with the network entity 502 via the backhaul link 514, and the NCR-FWD 510 may communicate with the UE 504 via the access link 516. The NCR-FWD 510 may support communicating via one or more transmit and/or receive beams towards the UE 504 and/or the network entity 502. The behavior of the NCR-FWD 510 may be controlled according to the side control information received from the network entity 502 via the control link 512.

In certain aspects, the NCR may perform frequency translation to forward signals between the UE and the network entity. For example, the NCR may obtain signals at a first frequency from the UE. The NCR may translate the signals to a second frequency and send the translated signals at the second frequency to the network entity, or vice versa.

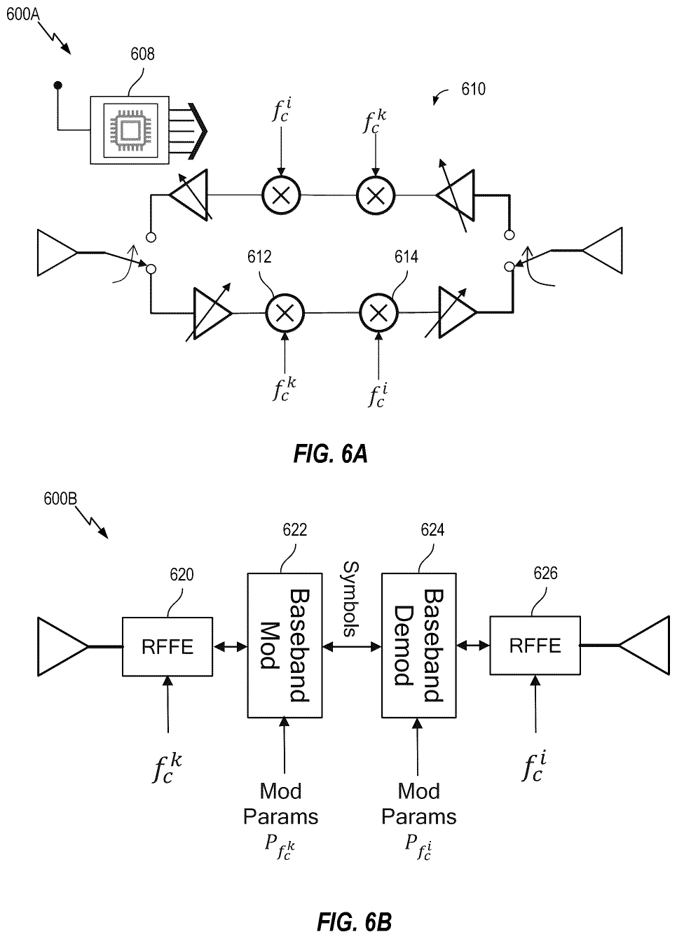

FIG. 6A depicts an example NCR 600A that performs frequency translation.

In this example, the NCR 600A includes an NCR-MT 608 and an NCR-FWD 610, for example, as described herein with respect to FIG. 5. The NCR-FWD 610 may perform frequency translation from a first carrier frequency (e.g., fk) through downconversion mixing to a baseband or an intermediate frequency and then upconversion mixing to a second carrier frequency (e.g., f). For example, the NCR-FWD 610 may include at least one cascade of mixers, where a first mixer 612 may perform the downconversion, and a second mixer 614 may perform the upconversion.

FIG. 6B depicts an example NCR-FWD 600B that performs frequency translation with digital signal processing. For example, the frequency translation from FR1 to FR2 (or vice versa) may involve digital signal processing. In certain aspects, the frequency translation may involve a modulation scheme translation. The NCR-FWD 600B may translate a signal from a first modulation scheme (e.g., QPSK) to a second modulation scheme (e.g., QAM), or vice versa. In certain aspects, the frequency translation may involve translating certain communications parameters (modulation parameters), such as an OFDM numerology, subcarrier spacing, slot format, the total number of MIMO layers, carrier bandwidth, code rate, etc.

The NCR-FWD 600B may demodulate a first signal at (or associated with) a first carrier frequency (e.g., f_{c}ⁱ) with a first set of modulation parameters (e.g., P_{f}_{_{c}}ⁱ), and then, the NCR-FWD may modulate a second signal at a second carrier frequency (e.g., f_{c}^{k}) with a second set of modulation parameters (e.g., P_{f}_{_{c}}^{k}) based on the first signal. As an example, the NCR-FWD 600B may include a first transceiver 620 (e.g., an RF front-end (RFFE) circuit), a demodulator 622, a modulator 624, and a second transceiver 626. The first transceiver 620 may receive RF signals, convert the RF signals to analog baseband signals, and feed the analog baseband signals to the demodulator 622. The demodulator 622 may convert (or decode) the analog baseband signals to one or more symbols associated with a digital modulation scheme. In certain aspects, the demodulator 622 may decode the symbols into a set of bits. The modulator 624 may convert the symbol(s) to analog baseband signal(s) and feed the analog baseband signal(s) to the second transceiver 626, which may output the second signal at the second carrier frequency.

### Aspects Related to Frequency Translating Repeater

Aspects of the present disclosure provide techniques for wireless communications via a frequency translating repeater. The frequency translation may enable frequency diversity for communications between a UE and a network entity. The frequency diversity may improve the signal quality and/or signal strength encountered at the network entity.

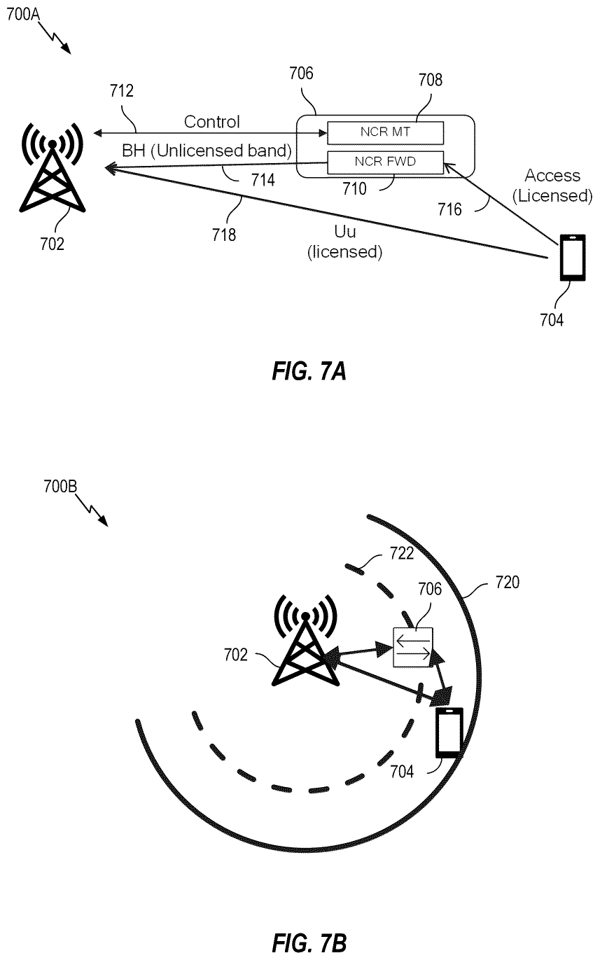

FIG. 7A depicts an example wireless communications system 700A where an NCR 706 performs frequency translation between a first frequency spectrum and a second frequency spectrum. In this example, the NCR 706 may forward uplink communications from a UE 704 to a network entity 702 via an access link 716 in the first frequency spectrum and a backhaul link 714 in the second frequency spectrum. The NCR 706 may translate uplink traffic from the first frequency spectrum to the second frequency spectrum, for example, as described herein with respect to FIGS. 6A and 6B. The NCR 706 may obtain, from the UE 704, the uplink traffic via the first frequency spectrum (e.g., a licensed frequency spectrum), and the NCR 706 may send, to the network entity 702, the uplink traffic via the second frequency spectrum (e.g., an unlicensed or shared frequency spectrum). As an example, the NCR 706 may obtain, from the UE 704, a first signal via the first frequency spectrum; and the NCR 706 may send, to the network entity 702, a second signal via the second frequency spectrum based on the first signal. The UE 704 may send the first signal via the first spectrum, and the first signal may include, for example, IoT communications, an uplink SRS, PRACH communications, discontinuous transmission (DTX) occasions, any suitable signaling and/or data, or the like.

In certain aspects, the network entity 702 may combine the signals received from the NCR 706 via the backhaul link 714 and the UE via the uplink 718. As an example, the network entity 702 may receive the first signal in the first frequency spectrum from the UE 704 via the uplink 718 and the second signal in the second frequency spectrum from the NCR 706 via the backhaul link 714, and the network entity 702 may decode the information (e.g., the payload) carried via the first signal and the second signal based on the first signal and the second signal. The second frequency spectrum may enable spectral diversity for communications between the UE 704 and the network entity 702. Combining the signals at the network entity 702 may improve the reliability of communications between the UE 704 and the network entity 702. The second frequency spectrum may avoid interference from communications via the first frequency spectrum, or vice versa. In addition, the NCR 706 may amplify or boost the signal strength of the second signal to be reliably received at the network entity 702.

In certain aspects, the first frequency spectrum may be or include a licensed frequency spectrum, and the second frequency spectrum may be or include an unlicensed or shared frequency spectrum. For the shared frequency spectrum, the NCR 706 may communicate via certain contention-based channel access technique(s), such as a LBT procedure including a Type 1 uplink channel access procedure or a Type 2 uplink channel access procedure as specified for 5G NR systems or the like. In certain cases, the NCR 706 may perform a channel access procedure (e.g., LBT) to evaluate the availability of a channel for performing transmissions. For example, when the NCR 706 detects that a channel in the second frequency spectrum is idle (e.g., the energy detected in the channel is less than a threshold) during a sensing period, the NCR 706 may transmit a signal via the channel in the second frequency spectrum.

In certain aspects, the NCR 706 may obtain, from the network entity 702 via the control link 712, a configuration that indicates one or more parameters for forwarding communications between the UE 704 and the network entity 702 via frequency translation. In certain cases, the configuration may indicate or include one or more transmission opportunities for communications via the backhaul link 714. In certain cases, a transmission opportunity for communications via the backhaul link 714 may be referred to as a backhaul link transmission opportunity. A transmission opportunity may provide an occasion (e.g., a time period, time-domain resource(s), and/or frequency-domain resource(s)) for communicating a signal (e.g., after contention for the occasion has been obtained, for example, by the NCR 706 and/or the network entity 702). In certain cases, the network entity 702 may ensure that one or more transmission opportunities in the second frequency spectrum are available for the NCR 706 by sending signal(s) in the second frequency spectrum to occupy the channel and share such channel occupancy with the NCR 706, for example, for a channel occupancy time (COT). Accordingly, a transmission opportunity may overlap in time with the channel occupancy time obtained by the network entity 702 and/or the NCR 706. The NCR 706 may obtain, from the network entity 702, an indication to activate, deactivate, and/or update the backhaul transmission opportunities, for example, via radio resource control (RRC) signaling and/or medium access control (MAC) signaling (e.g., a MAC control element (MAC-CE)) over the control link.

In certain aspects, the one or more transmission opportunities may correspond to a set of transmission occasions (e.g., uplink transmission occasions) allocated in the first frequency spectrum for the UE 704. For example, the configuration may indicate or include the set of transmission occasions allocated to the UE. In certain cases, the set of transmission occasions may allocate resource(s) (e.g., time-frequency resource(s)) for the UE 704 to communicate with the network entity 702 via the uplink 718 (e.g., a Uu interface). In certain aspects, the set of transmission occasions may be or include dynamically scheduled resource(s) (for example, via DCI), semi-persistent resource(s), and/or periodic resource(s). As an example, the set of transmission occasions may be allocated for the UE 704 via a configured grant or a grant-free uplink configuration, such as via RRC signaling and/or MAC signaling. In certain aspects, the transmission opportunities may correspond to one or more transmission occasions of sounding reference signal (SRS) transmission from the UE 704.

In certain aspects, the configuration may indicate a contention-based channel access technique to use for the backhaul link 714. For example, the configuration may indicate to use the Type 1 uplink channel access procedure and/or the Type 2 uplink channel access procedure. The network entity 702 may determine the type of uplink channel access procedure to use for the backhaul link 714 based on the signal or traffic being forwarded by the NCR 706. In certain aspects, the configuration may indicate a channel access priority for the Type 1 uplink channel access procedure. A contention window for evaluating if a channel is idle may be adjusted based on the channel access priority.

FIG. 7B depicts an example wireless communications system 700B where the NCR 706 may be arranged in a coverage area 720 of a network entity 702. In certain cases, due to certain transmit power specifications (e.g., a maximum allowed transmit power) for a shared or unlicensed spectrum, the transmission range 722 via an unlicensed band may be shorter than the transmission range via a licensed band, and thus, the NCR 706 may be arranged in the coverage area 720 of the network entity 702. The NCR 706 may forward communications between the UE 704 and the network entity 702 through frequency translation as described herein with respect to FIG. 7A. Via the frequency translation, the NCR 706 may enable spectral diversity for communications between the UE 704 and the network entity 702 as described herein with respect to FIG. 7A. Accordingly, the frequency translation of the NCR 706 may enable reliable uplink communications between the UE 704 and the network entity 702, for example, when the UE 704 is positioned near the edge of the coverage area 720 of the network entity 702 (e.g., to improve cell edge or last-mile communications).

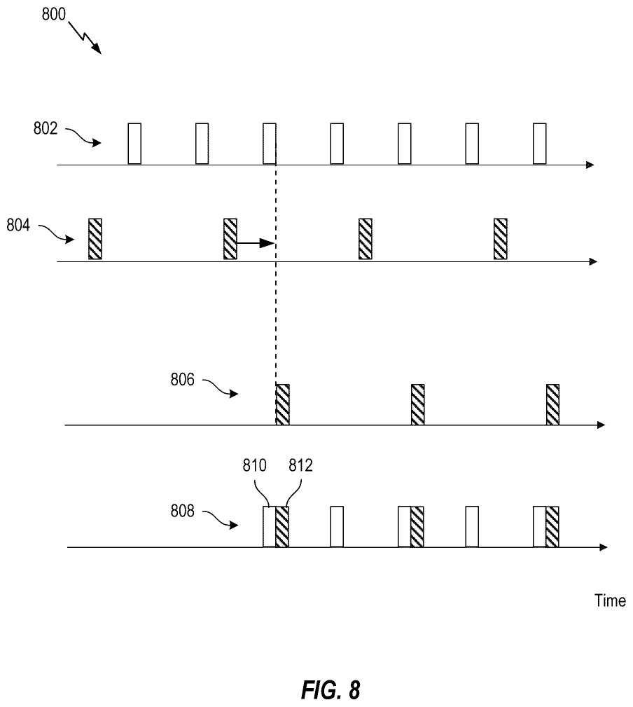

In certain aspects, a network entity may control the uplink grant management of multiple UEs to enable the forwarding of traffic from one or more of the UEs via an NCR. As an example, the NCR may be configured to forward periodic or semi-persistent uplink traffic from a first UE, for example, as described herein with respect to FIG. 7A. The network entity may identify that a second UE is communicating periodic or semi-persistent uplink traffic. In response to identifying the uplink traffic pattern of the second UE, the network entity may align the periodic or semi-persistent transmission occasions allocated to the second UE with the transmission occasion allocated to the first UE to enable the NCR to forward the traffic within the same channel occupancy time(s), for example, as further described herein with respect to FIG. 8. In certain cases, the network entity may determine that the NCR can be used for the forwarding traffic from measurement report(s) received from the second UE. The measurement report(s) may indicate that the second UE is within communication range of the NCR, for example, based on interference measurements of the second UE.

FIG. 8 depicts an example of uplink grant management 800 for forwarding traffic via an NCR from multiple UEs. In this example, a first UE may be allocated a first set of transmission occasions 802 (e.g., periodic or semi-persistent) for uplink communications in a first frequency spectrum (e.g., a licensed spectrum), and an NCR may be configured to forward the uplink traffic of the first UE via a second frequency spectrum (e.g., an unlicensed or shared spectrum), for example, as described herein with respect to FIG. 7A. The first set of transmission occasions 802 may correspond to a set of backhaul link transmission opportunities allocated to the NCR for forwarding the traffic of the first UE. For example, the backhaul link transmission opportunities may (partially or completely) overlap in time with the first set of transmission occasions. In certain cases, a configuration for forwarding the uplink traffic of the first UE applied at the NCR may indicate that the transmission opportunities are associated with a first channel access priority (e.g., a channel access priority set as ‘1’).

A second UE may be allocated a second set of transmission occasions 804 (e.g., dynamically, periodic, or semi-persistent) for uplink communications in the first frequency spectrum. The second set of transmission occasions 804 may not be aligned with the first set of transmission occasions 802. A network entity may identify that the uplink traffic from the second UE can be forwarded by the NCR. The network entity may adjust the allocation of the second set of transmission occasions 804 to align with the first set of transmission occasions 802. For example, an instance of the second set of transmission occasions may occur (e.g., immediately or within a threshold) after (e.g., or before) an instance of the first set of transmission occasions (or vice versa). The network entity may send, to the second UE, an indication of the updated allocation 806 for the second set of transmission occasions.

The network entity may send, to the NCR via a control link, a configuration that indicates backhaul link transmission opportunities 808 to forward the uplink traffic of the first UE and the second UE. The transmission opportunities may include a first set of transmission opportunities associated with the uplink traffic of the first UE and a second set of transmission opportunities associated with the uplink traffic of the second UE. In certain cases, the second set of transmission opportunities may be aligned with the first set of transmission opportunities, such that an instance of the second set of transmission opportunities may occur (e.g., immediately or within a threshold) after (e.g., or before) an instance of the first set of transmission opportunities (or vice versa). In certain cases, the second set of transmission opportunities may be assigned a second channel access priority (e.g., a channel access priority set as ‘2’), which may be the same or different than the first channel access priority associated with the first set of transmission opportunities.

As an example, the backhaul link transmission opportunities 808 may include a first transmission opportunity 810 for forwarding uplink traffic of the first UE and a second transmission opportunity 812 for forwarding uplink traffic of the second UE. The first transmission opportunity 810 and the second transmission opportunity 812 may occur within a (same) channel occupancy time for shared spectrum communications. In certain cases, the second transmission opportunity 812 may occur (e.g., immediately or within a threshold) after (e.g., or before) the first transmission opportunity 810, or vice versa. Such arrangement(s) in time for the first transmission opportunity 810 and the second transmission opportunity 812 may allow the NCR to use the same channel occupancy time for forwarding uplink traffic via the second frequency spectrum without channel sensing for the second transmission opportunity. Accordingly, the uplink grant management may reduce or eliminate the time used for channel sensing at the NCR for LBT to forward the traffic in the second transmission opportunity.

In certain aspects, the NCR may detect that there is no uplink transmission in a transmission occasion from a UE via the access link to forward on the backhaul link. The NCR may obtain an indication of when to expect uplink transmission(s) from a UE, for example, based on one or more transmission opportunities described herein. The NCR may monitor the access link for uplink transmission(s) from the UE in transmission occasion(s) that correspond to the one or more transmission opportunities for backhaul link communications. The NCR may evaluate whether there is an uplink transmission on the access link based on radio measurement(s) of a first frequency spectrum associated with the access link satisfying a threshold. The NCR may obtain (via a pre-configuration and/or signaling) an indication of one or more frequency bandwidths (e.g., one or more frequency resources) of the first frequency spectrum to monitor for uplink transmission(s) to forward. In certain aspects, the NCR may obtain (via a pre-configuration and/or signaling) an indication of which transmission opportunities to perform radio measurement(s). The radio measurement(s) may include, for example, a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER). As an example, the NCR may detect that there is no uplink transmission when the signal strength (e.g., RSRP) and/or signal quality (e.g., SINR) is less than a threshold.

In response to detecting that there is no uplink transmission over the access link in a transmission occasion associated with a transmission opportunity, the NCR may perform one or more actions. In certain cases, the NCR may refrain from outputting a signal via the backhaul link, for example, in the transmission opportunity corresponding to the transmission occasion. As an example, when there is no subsequent transmission opportunity that shares the same channel occupancy time as the transmission opportunity, the NCR may refrain from outputting a signal in the transmission opportunity.

In certain cases, the NCR may output, in the transmission opportunity, a signal via the backhaul link with a partial frequency band translation. As an example, suppose the NCR is configured to translate a signal from a first frequency band to a second frequency band, the NCR may translate a signal from a portion of the first frequency band to a portion of the second frequency band.

In certain cases, the NCR may output, in the transmission opportunity, a reservation signal via the backhaul link in the second frequency spectrum. The communication of the reservation signal may allow the NCR to maintain access to the channel on the backhaul link for a subsequent transmission opportunity, which may share the channel occupancy time of the transmission opportunity. In certain aspects, the NCR may send, to the network entity, an indication that the reservation signal is being communicated in the transmission opportunity. The indication of the reservation signal may be communicated via a control link between the NCR and the network entity. The indication of the reservation signal may enable the network entity to determine whether to deactivate or modify the UE's resource allocation for the transmission occasion(s). In certain aspects, the indication of the reservation signal may trigger the network entity to evaluate the channel state between the UE and the network entity and/or the between the UE and the NCR. For example, the network entity may configure the UE to send one or more pilot signals via the access link. In certain aspects, the NCR may obtain, via a pre-configuration and/or signaling, an indication of the transmit power level to use for transmission of the reservation signal.

In certain cases, the NCR may detect that the signal(s) obtained via the access link have a signal strength greater than a first threshold and less than a second threshold. In such cases, the NCR may boost or amplify the signal(s) for transmission via the second frequency spectrum. The NCR may send the signal(s) with an amplified power level via the second frequency spectrum. The NCR may obtain (e.g., via a pre-configuration or signaling) an indication of the transmit power level to use for power amplification for translating the signals obtained via the access link. The power amplification may be (e.g., pre) configured or determined based on the energy detection threshold for LBT and/or a transmission range at the NCR (e.g., a hypothetical transmission range estimate).

In certain aspects, the NCR may obtain, such as via a pre-configuration and/or signaling, an indication to refrain from forwarding signal(s) when the signal strength associated with a set of frequency resources (which may be different from the frequency resource(s) allocated to a UE for uplink communications and frequency translation) is above a threshold, for example, to avoid forwarding interference over the second frequency spectrum. This behavior may depend on the NCR's capability to filter out or reject interference in the set of frequency resources. Suppose the NCR would forward signals in adjacent channel(s) relative to the frequency resource(s) allocated to a UE due to the filtering capabilities of the NCR, then the NCR may refrain from forwarding signal(s) when the signal strength in the adjacent channel(s) is above a threshold.

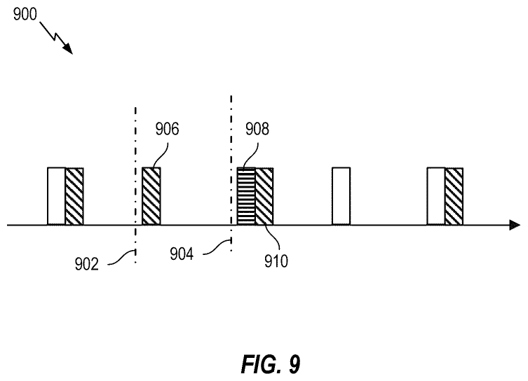

FIG. 9 depicts an example of NCR behavior 900 when no uplink transmission is detected on the access link. In this example, the NCR may detect that there is no uplink transmission via the access link at a first occasion 902 (e.g., a first time period) and a second occasion 904 (e.g., a second time period), for example, with respect to a signal strength evaluation of the access link as discussed herein. In response to there being no uplink transmission detected at the first occasion 902, the NCR may refrain from transmitting a signal via the backhaul link in a first transmission opportunity 906, for example, due to there being no subsequent transmission opportunity that shares the channel occupancy time of the first transmission opportunity 906. In response to there being no uplink transmission at the second occasion 904, the NCR may send a reservation signal in a second transmission opportunity 908, for example, due to there being a subsequent transmission opportunity 910 that shares the channel occupancy time of the second transmission opportunity 908. The subsequent transmission opportunity may be used to forward communications from another UE, for example, as described herein with respect to FIG. 8.

### Example Signaling for Wireless Communications Via a Frequency Translating Repeater

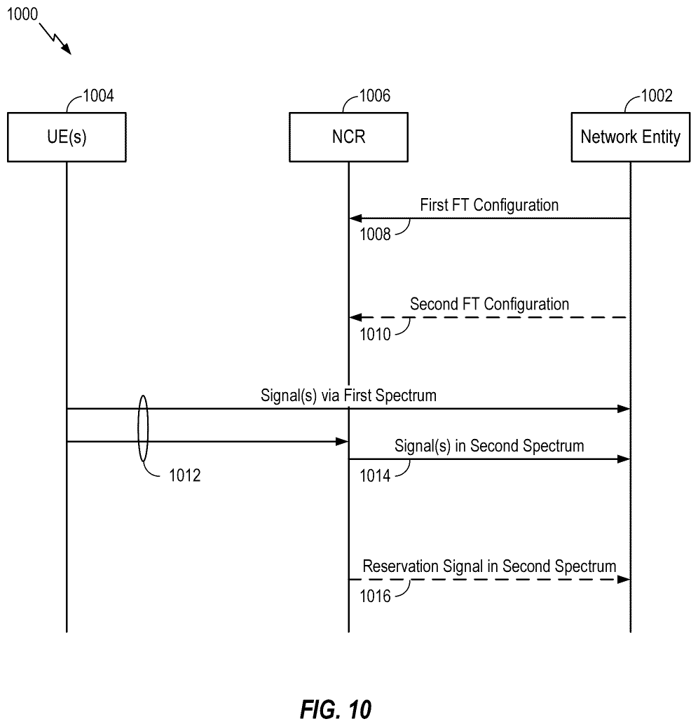

FIG. 10 depicts a process flow 1000 for signaling for wireless communications via a frequency translating repeater in a system including a network entity 1002, a user equipment (UE) 1004, and a network-controlled repeater (NCR) 1006. In some aspects, the network entity 1002 may be an example of the BS 102 depicted and described with respect to FIGS. 1 and 3 or a disaggregated base station depicted and described with respect to FIG. 2. Similarly, the UE 1004 may be an example of UE 104 depicted and described with respect to FIGS. 1 and 3. In certain aspects, the NCR 1006 may be an example of the NCR 706 depicted and described with respect to FIG. 7A. However, in other aspects, UE 1004 may be another type of wireless communications device, and the network entity 1002 may be another type of network entity or network node, such as those described herein. Note that any operations or signaling illustrated with dashed lines may indicate that that operation or signaling is an optional or alternative example.

At 1008, the NCR 1006 obtains, from the network entity 1002, a first frequency translation (FT) configuration that indicates one or more first backhaul link transmission opportunities for translating one or more signals from a first frequency spectrum (e.g., a licensed frequency spectrum) to a second frequency spectrum (e.g., a shared or unlicensed frequency spectrum), for example, as described herein with respect to FIG. 7A. In certain aspects, the first FT configuration may indicate a set of transmission occasions allocated to the UE 1004 for communications via an access link and/or an uplink. The first FT configuration may be communicated via RRC signaling, MAC signaling, DCI, and/or system information through a control link.

At 1010, the NCR 1006 may obtain, from the network entity 1002, a second FT configuration that may activate, deactivate, and/or modify the backhaul transmission opportunities assigned to the NCR 1006. As an example, the second FT configuration may indicate an additional set of transmission opportunities that share channel occupancy times with another set of transmission opportunities, as described herein with respect to FIG. 8. The second configuration may be communicated via RRC signaling, MAC signaling, DCI, and/or system information through a control link.

At 1012, the NCR 1006 obtains, from the UE 1004, one or more first signals via the first frequency spectrum, for example, in a set of uplink transmission occasions on the access link. In certain cases, the network entity 1002 may obtain, from the UE 1004, the first signal(s) via the first frequency spectrum, for example, to enable combined decoding through the first frequency spectrum and the second frequency spectrum.

At 1014, the NCR 1006 sends, to the network entity 1002, one or more second signals via the second frequency spectrum via a backhaul link based on the first signal(s). The NCR may convert the first signal(s) in the first frequency spectrum to the second signal(s) in the second frequency spectrum. The transmission of the second signal(s) via the second frequency spectrum may enable spectral diversity for the communications between the UE 1004 and the network entity 1002.

In certain aspects, the network entity 1002 may combine the signals received from the NCR 1006 via the backhaul link and the UE 1004 via the uplink. As an example, the network entity 1002 may receive the first signal(s) in the first frequency spectrum from the UE 1004 via the uplink and the second signal(s) in the second frequency spectrum from the NCR 1006 via the backhaul link, and the network entity 1002 may decode the information carried via the first signal(s) and the second signal(s) based on the first signal(s) and the second signal(s). In certain cases, the network entity 1002 may combine the symbols associated with the first signal(s) and the second signal(s). In certain cases, the network entity 1002 may perform error correction techniques using the information carried via the first signal(s) and the second signal(s). Accordingly, combining the signals at the network entity 1002 may improve the reliability of communications between the UE 1004 and the network entity 1002.

At 1016, the NCR 1006 may send, to the network entity 1002, a reservation signal, for example, when one or more radio measurements of the first frequency spectrum satisfy a threshold (e.g., when the signal strength in the first frequency spectrum is less than or equal to a threshold). The reservation signal may be used to ensure a channel occupancy time is available for a subsequent transmission via the second frequency spectrum, for example, as described herein with respect to FIG. 9.

Note that the process flow illustrated in FIG. 10 is described herein to facilitate an understanding of wireless communications via a frequency translating repeater and aspects of the present disclosure may be performed in various manners via alternative or additional signaling and/or operations. In certain aspects, the operations and/or signaling of FIG. 10 may occur in an order different from that described or depicted, and various actions, operations, and/or signaling may be added, omitted, or combined.

### Example Operations Related to Wireless Communications Via a Frequency Translating Repeater

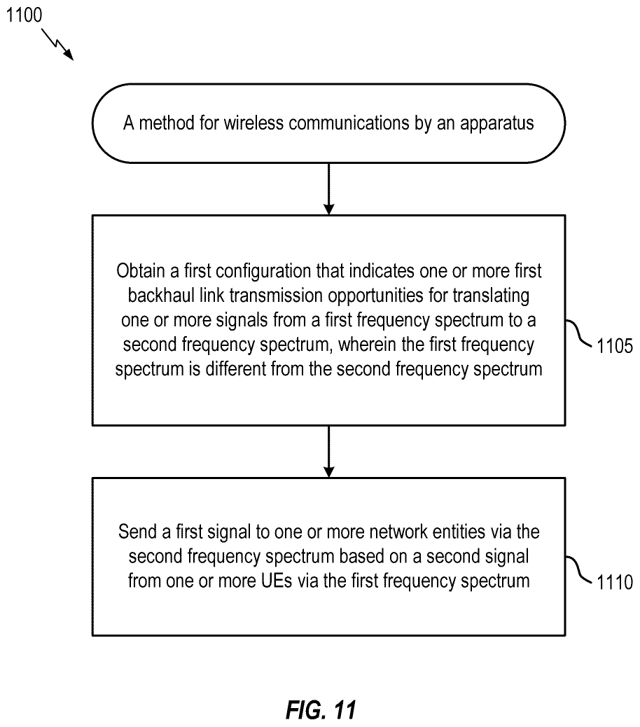

FIG. 11 shows a method 1100 for wireless communications by an apparatus, such as the NCR 506, 706 of FIGS. 5 and 7A.

Method 1100 begins at block 1105 with obtaining a first configuration that indicates one or more first backhaul link transmission opportunities for translating one or more signals from a first frequency spectrum to a second frequency spectrum, wherein the first frequency spectrum is different from the second frequency spectrum, for example, as described herein with respect to FIGS. 7A and 10. In certain aspects, the first frequency spectrum is a licensed spectrum; and the second frequency spectrum is a shared spectrum. In certain aspects, the shared spectrum is an unlicensed spectrum.

Method 1100 then proceeds to block 1110 with sending a first signal to one or more network entities via the second frequency spectrum based on a second signal from one or more UEs via the first frequency spectrum, for example, as described herein with respect to FIGS. 7A and 10. The frequency translation may enable spectral diversity for communications between a UE and a network entity, and thus, the frequency translation may improve the signal quality and/or signal strength encountered at the network entity.

In certain aspects, method 1100 further includes obtaining, from the one or more UEs, the second signal via the first frequency spectrum; and wherein block 1110 includes converting the second signal in the first frequency spectrum to the first signal in the second frequency spectrum.

In certain aspects, block 1110 includes sending the first signal in at least one backhaul link transmission opportunity of the one or more first backhaul link transmission opportunities.

In certain aspects, the one or more first backhaul link transmission opportunities correspond to a set of transmission occasions allocated in the first frequency spectrum for the one or more UEs. In certain aspects, the set of transmission occasions comprises one or more of: one or more semi-persistent resources or one or more periodic resources. In certain aspects, the one or more first backhaul link transmission opportunities correspond to one or more transmission occasions of one or more sounding reference signal transmissions from the one or more UEs.

In certain aspects, the first configuration comprises one or more of: an indication of a channel access procedure to use for communications via the second frequency spectrum; a channel access priority class associated with at least one backhaul link transmission opportunity of the one or more first backhaul link transmission opportunities; or an indication of one or more frequency resources to use for communications via the second frequency spectrum.

In certain aspects, method 1100 further includes obtaining an indication to activate the one or more first backhaul link transmission opportunities for translating the one or more signals; and block 1110 includes sending the first signal in response to the indication to activate the one or more first backhaul link transmission opportunities.

In certain aspects, method 1100 further includes obtaining an indication to deactivate the one or more first backhaul link transmission opportunities.

In certain aspects, method 1100 further includes obtaining a second configuration that indicates one or more second backhaul link transmission opportunities for the second frequency spectrum via an NCR.

In certain aspects, the first configuration comprises an indication to monitor one or more transmission occasions via the first frequency spectrum corresponding to the one or more first backhaul link transmission opportunities, for example, to evaluate whether there is an uplink transmission to forward.

In certain aspects, the first configuration comprises an indication to refrain from translating communications based on one or more radio measurements of the first frequency spectrum satisfying a threshold.

In certain aspects, the first configuration comprises an indication to translate communications via a portion of the second frequency spectrum based on one or more radio measurements of the first frequency spectrum satisfying a threshold.

In certain aspects, method 1100 further includes refraining from sending a transmission in a backhaul link transmission opportunity via the second frequency spectrum when one or more radio measurements of the first frequency spectrum satisfy a threshold.

In certain aspects, method 1100 further includes sending a reservation signal in a backhaul link transmission opportunity via the second frequency spectrum when one or more radio measurements of the first frequency spectrum satisfy a threshold.

In certain aspects, the first configuration comprises an indication of a transmit power level to use for transmission of the reservation signal.

In certain aspects, method 1100 further includes sending an indication that the reservation signal is being communicated in the backhaul link transmission opportunity.

In certain aspects, method 1100 further includes sending the first signal with an amplified power level via the second frequency spectrum based on one or more radio measurements of the first frequency spectrum satisfying a threshold.

In certain aspects, the first configuration comprises an indication of a transmit power level to use for power amplification for translating the one or more signals.

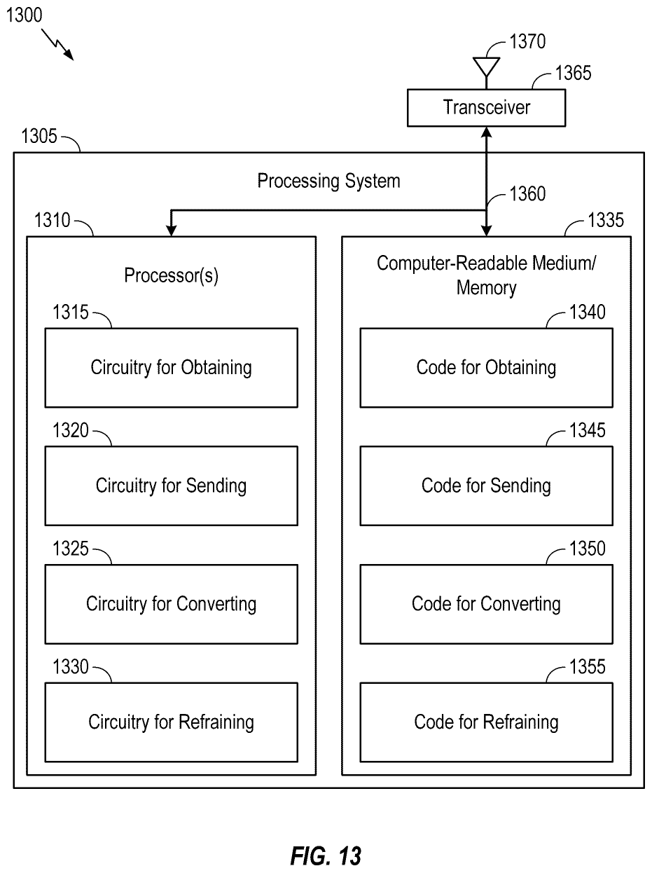

In certain aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

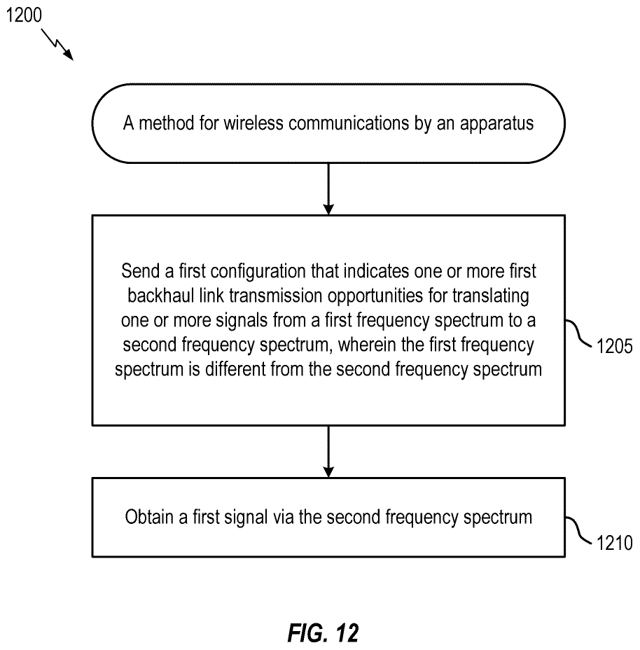

FIG. 12 shows a method 1200 for wireless communications by an apparatus, such as BS 102 of FIGS. 1 and 3, or a disaggregated base station as discussed with respect to FIG. 2.

Method 1200 begins at block 1205 with sending a first configuration that indicates one or more first backhaul link transmission opportunities for translating one or more signals from a first frequency spectrum to a second frequency spectrum, wherein the first frequency spectrum is different from the second frequency spectrum, for example, as described herein with respect to FIGS. 7A and 10. In certain aspects, the first frequency spectrum is a licensed spectrum; and the second frequency spectrum is a shared spectrum. In certain aspects, the shared spectrum is an unlicensed spectrum.

Method 1200 then proceeds to block 1210 with obtaining a first signal via the second frequency spectrum, for example, as described herein with respect to FIGS. 7A and 10. The frequency translation may enable spectral diversity for communications between a UE and a network entity, and thus, the frequency translation may improve the signal quality and/or signal strength encountered at the network entity.

In certain aspects, block 1210 includes obtaining the first signal in at least one backhaul link transmission opportunity of the one or more first backhaul link transmission opportunities.

In certain aspects, the one or more first backhaul link transmission opportunities correspond to a set of transmission occasions allocated in the first frequency spectrum for the one or more UEs. For example, the set of transmission occasions may (partially or completely) overlap in time with the first backhaul link transmission opportunities.

In certain aspects, the set of transmission occasions comprises one or more of: one or more semi-persistent resources or one or more periodic resources.

In certain aspects, the one or more first backhaul link transmission opportunities correspond to one or more transmission occasions of one or more sounding reference signal transmissions from the one or more UEs.

In certain aspects, the first configuration comprises one or more of: an indication of a channel access procedure to use for communications via the second frequency spectrum; a channel access priority class associated with at least one backhaul link transmission opportunity of the one or more first backhaul link transmission opportunities; or an indication of one or more frequency resources to use for communications via the second frequency spectrum.

In certain aspects, method 1200 further includes sending an indication to activate the one or more first backhaul link transmission opportunities for translating the one or more signals; and block 1210 includes obtaining the first signal in response to the indication to activate the one or more first backhaul link transmission opportunities.

In certain aspects, method 1200 further includes sending an indication to deactivate the one or more first backhaul link transmission opportunities.

In certain aspects, method 1200 further includes sending a second configuration that indicates one or more second backhaul link transmission opportunities for the second frequency spectrum.

In certain aspects, the first configuration comprises an indication to monitor one or more transmission occasions via the first frequency spectrum corresponding to the one or more first backhaul link transmission opportunities, for example, to evaluate whether there is an uplink transmission to forward via an NCR.

In certain aspects, the first configuration comprises an indication to refrain from translating communications based on one or more radio measurements of the first frequency spectrum satisfying a threshold.

In certain aspects, the first configuration comprises an indication to translate communications via a portion of the second frequency spectrum based on one or more radio measurements of the first frequency spectrum satisfying a threshold.

In certain aspects, method 1200 further includes obtaining a reservation signal in a backhaul link transmission opportunity via the second frequency spectrum when one or more radio measurements of the first frequency spectrum satisfy a threshold.

In certain aspects, the first configuration comprises an indication of a transmit power level to use for transmission of the reservation signal.

In certain aspects, method 1200 further includes obtaining an indication that the reservation signal is being communicated in the backhaul link transmission opportunity.

In certain aspects, the first configuration comprises an indication of a transmit power level to use for power amplification for translating the one or more signals.

In certain aspects, method 1200 further includes sending a second configuration that indicates a set of transmission occasions allocated in the first frequency spectrum, wherein the one or more first backhaul link transmission opportunities correspond to the set of transmission occasions.

In certain aspects, method 1200 further includes obtaining a second signal via the first frequency spectrum.

In certain aspects, method 1200 further includes determining a payload of the first signal based on the first signal and the second signal.

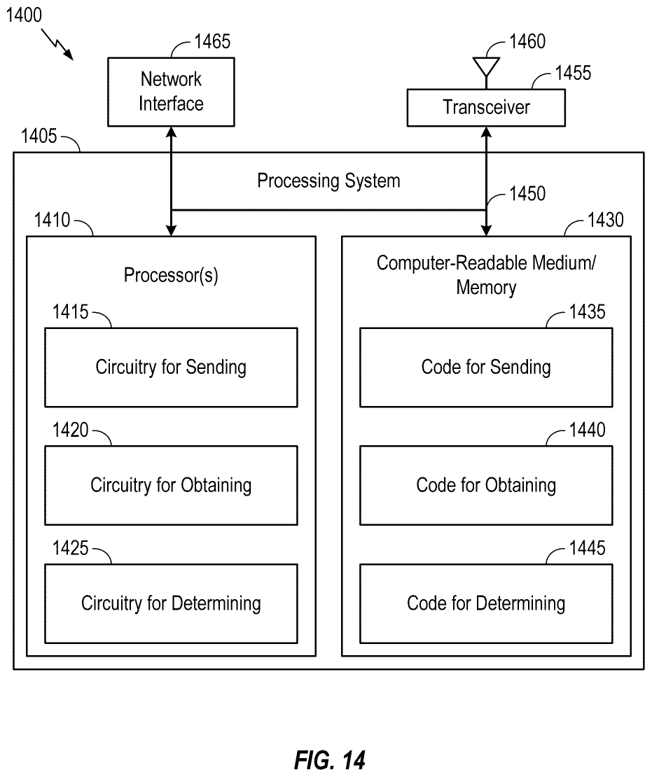

In certain aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Communications Devices

FIG. 13 depicts aspects of an example communications device 1300. In some aspects, communications device 1300 is a user equipment, such as UE 104 described above with respect to FIGS. 1 and 3, and/or an NCR, such as the NCR 506, 706 described above with respect to FIGS. 5 and 7A.

The communications device 1300 includes a processing system 1305 coupled to a transceiver 1365 (e.g., a transmitter and/or a receiver). The transceiver 1365 is configured to transmit and receive signals for the communications device 1300 via an antenna 1370, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. The one or more processors 1310 are coupled to a computer-readable medium/memory 1335 via a bus 1360. In certain aspects, the computer-readable medium/memory 1335 is configured to store instructions (e.g., computer-executable code), including code 1340-1355, that when executed by the one or more processors 1310, enable and cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1335 stores code for obtaining 1340, code for sending 1345, code for converting 1350, and code for refraining 1355. Processing of the code 1340-1355 may enable and cause the communications device 1300 to perform the method 1100 described with respect to FIG. 11, or any aspect related to it.

The one or more processors 1310 include circuitry configured to implement (e.g., execute) the code (e.g., executable instructions) stored in the computer-readable medium/memory 1335, including circuitry for obtaining 1315, circuitry for sending 1320, circuitry for converting 1325, and circuitry for refraining 1330. Processing with circuitry 1315-1330 may enable and cause the communications device 1300 to perform the method 1100 described with respect to FIG. 11, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1365 and/or antenna 1370 of the communications device 1300 in FIG. 13, and/or one or more processors 1310 of the communications device 1300 in FIG. 13. Means for communicating, receiving or obtaining may include the transceivers 354, antenna(s) 352, receive processor 358, AI processor 370, and/or controller/processor 380 of the UE 104 illustrated in FIG. 3, transceiver 1365 and/or antenna 1370 of the communications device 1300 in FIG. 13, and/or one or more processors 1310 of the communications device 1300 in FIG. 13. For example, means for converting and/or means for refraining may include one or more processors 1310 of the communications device 1300 in FIG. 13.

FIG. 14 depicts aspects of an example communications device 1400. In some aspects, communications device 1400 is a network entity, such as BS 102 of FIGS. 1 and 3, or a disaggregated base station as discussed with respect to FIG. 2.

The communications device 1400 includes a processing system 1405 coupled to a transceiver 1455 (e.g., a transmitter and/or a receiver) and/or a network interface 1465. The transceiver 1455 is configured to transmit and receive signals for the communications device 1400 via an antenna 1460, such as the various signals as described herein. The network interface 1465 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1430 via a bus 1450. In certain aspects, the computer-readable medium/memory 1430 is configured to store instructions (e.g., computer-executable code), including code 1435-1445, that when executed by the one or more processors 1410, enable and cause the one or more processors 1410 to perform the method 1200 described with respect to FIG. 12, or any aspect related to it, including any operations described in relation to FIG. 12. Note that reference to a processor of communications device 1400 performing a function may include one or more processors of communications device 1400 performing that function, such as in a distributed fashion.

In the depicted example, the computer-readable medium/memory 1430 stores code for sending 1435, code for obtaining 1440, and code for determining 1445. Processing of the code 1435-1445 may enable and cause the communications device 1400 to perform the method 1200 described with respect to FIG. 12, or any aspect related to it.

The one or more processors 1410 include circuitry configured to implement (e.g., execute) the code (e.g., executable instructions) stored in the computer-readable medium/memory 1430, including circuitry for sending 1415, circuitry for obtaining 1420, and circuitry for determining 1425. Processing with circuitry 1415-1425 may enable and cause the communications device 1400 to perform the method 1200 described with respect to FIG. 12, or any aspect related to it.

Various components of the communications device 1400 may provide means for performing the method 1200 described with respect to FIG. 12, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1455, antenna 1460, and/or network interface 1465 of the communications device 1400 in FIG. 14, and/or one or more processors 1410 of the communications device 1400 in FIG. 14. Means for communicating, receiving or obtaining may include the transceivers 332, antenna(s) 334, receive processor 338, AI processor 318, and/or controller/processor 340 of the BS 102 illustrated in FIG. 3, transceiver 1455, antenna 1460, and/or network interface 1465 of the communications device 1400 in FIG. 14, and/or one or more processors 1410 of the communications device 1400 in FIG. 14. Means for means for determining may include one or more processors 1410 of the communications device 1400 in FIG. 14.

### Example Clauses

Implementation examples are described in the following numbered clauses:

Clause 1: A method for wireless communications by an apparatus comprising: obtaining a first configuration that indicates one or more first backhaul link transmission opportunities for translating one or more signals from a first frequency spectrum to a second frequency spectrum, wherein the first frequency spectrum is different from the second frequency spectrum; and sending a first signal to one or more network entities via the second frequency spectrum based on a second signal from one or more UEs via the first frequency spectrum.

Clause 2: The method of Clause 1, further comprising obtaining, from the one or more UEs, the second signal via the first frequency spectrum; and wherein sending the first signal comprises converting the second signal in the first frequency spectrum to the first signal in the second frequency spectrum.

Clause 3: The method of any one of Clauses 1-2, wherein: the first frequency spectrum is a licensed spectrum; and the second frequency spectrum is a shared spectrum.

Clause 4: The method of Clause 3, wherein the shared spectrum is an unlicensed spectrum.

Clause 5: The method of any one of Clauses 1-4, wherein sending the first signal comprises sending the first signal in at least one backhaul link transmission opportunity of the one or more first backhaul link transmission opportunities.

Clause 6: The method of any one of Clauses 1-5, wherein the one or more first backhaul link transmission opportunities correspond to a set of transmission occasions allocated in the first frequency spectrum for the one or more UEs.

Clause 7: The method of Clause 6, wherein the set of transmission occasions comprises one or more of: one or more semi-persistent resources or one or more periodic resources.

Clause 8: The method of any one of Clauses 1-7, wherein the one or more first backhaul link transmission opportunities correspond to one or more transmission occasions of one or more sounding reference signal transmissions from the one or more UEs.

Clause 9: The method of any one of Clauses 1-8, wherein the first configuration comprises one or more of: an indication of a channel access procedure to use for communications via the second frequency spectrum; a channel access priority class associated with at least one backhaul link transmission opportunity of the one or more first backhaul link transmission opportunities; or an indication of one or more frequency resources to use for communications via the second frequency spectrum.

Clause 10: The method of any one of Clauses 1-9, further comprising obtaining an indication to activate the one or more first backhaul link transmission opportunities for translating the one or more signals; and sending the first signal comprises sending the first signal in response to the indication to activate the one or more first backhaul link transmission opportunities.

Clause 11: The method of any one of Clauses 1-10, further comprising obtaining an indication to deactivate the one or more first backhaul link transmission opportunities.

Clause 12: The method of any one of Clauses 1-11, further comprising obtaining a second configuration that indicates one or more second backhaul link transmission opportunities for the second frequency spectrum.

Clause 13: The method of any one of Clauses 1-12, wherein the first configuration comprises an indication to monitor one or more transmission occasions via the first frequency spectrum corresponding to the one or more first backhaul link transmission opportunities.

Clause 14: The method of Clause 13, wherein the first configuration comprises an indication to refrain from translating communications based on one or more radio measurements of the first frequency spectrum satisfying a threshold.

Clause 15: The method of any one of Clauses 1-14, wherein the first configuration comprises an indication to translate communications via a portion of the second frequency spectrum based on one or more radio measurements of the first frequency spectrum satisfying a threshold.

Clause 16: The method of any one of Clauses 1-15, further comprising refraining from sending a transmission in a backhaul link transmission opportunity via the second frequency spectrum when one or more radio measurements of the first frequency spectrum satisfy a threshold.

Clause 17: The method of any one of Clauses 1-16, further comprising sending a reservation signal in a backhaul link transmission opportunity via the second frequency spectrum when one or more radio measurements of the first frequency spectrum satisfy a threshold.

Clause 18: The method of Clause 17, wherein the first configuration comprises an indication of a transmit power level to use for transmission of the reservation signal.

Clause 19: The method of Clause 17, further comprising sending an indication that the reservation signal is being communicated in the backhaul link transmission opportunity.

Clause 20: The method of any one of Clauses 1-19, further comprising sending the first signal with an amplified power level via the second frequency spectrum based on one or more radio measurements of the first frequency spectrum satisfying a threshold.

Clause 21: The method of any one of Clauses 1-20, wherein the first configuration comprises an indication of a transmit power level to use for power amplification for translating the one or more signals.

Clause 22: A method for wireless communications by an apparatus comprising: sending a first configuration that indicates one or more first backhaul link transmission opportunities for translating one or more signals from a first frequency spectrum to a second frequency spectrum, wherein the first frequency spectrum is different from the second frequency spectrum; and obtaining a first signal via the second frequency spectrum.

Clause 23: The method of Clause 22, wherein: the first frequency spectrum is a licensed spectrum; and the second frequency spectrum is a shared spectrum.

Clause 24: The method of Clause 23, wherein the shared spectrum is an unlicensed spectrum.

Clause 25: The method of any one of Clauses 22-24, wherein obtaining the first signal comprises obtaining the first signal in at least one backhaul link transmission opportunity of the one or more first backhaul link transmission opportunities.

Clause 26: The method of any one of Clauses 22-25, wherein the one or more first backhaul link transmission opportunities correspond to a set of transmission occasions allocated in the first frequency spectrum for the one or more UEs.

Clause 27: The method of Clause 26, wherein the set of transmission occasions comprises one or more of: one or more semi-persistent resources or one or more periodic resources.

Clause 28: The method of any one of Clauses 22-27, wherein the one or more first backhaul link transmission opportunities correspond to one or more transmission occasions of one or more sounding reference signal transmissions from the one or more UEs.

Clause 29: The method of any one of Clauses 22-28, wherein the first configuration comprises one or more of: an indication of a channel access procedure to use for communications via the second frequency spectrum; a channel access priority class associated with at least one backhaul link transmission opportunity of the one or more first backhaul link transmission opportunities; or an indication of one or more frequency resources to use for communications via the second frequency spectrum.

Clause 30: The method of any one of Clauses 22-29, further comprising sending an indication to activate the one or more first backhaul link transmission opportunities for translating the one or more signals; and obtaining the first signal comprises obtaining the first signal in response to the indication to activate the one or more first backhaul link transmission opportunities.

Clause 31: The method of any one of Clauses 22-30, further comprising sending an indication to deactivate the one or more first backhaul link transmission opportunities.

Clause 32: The method of any one of Clauses 22-31, further comprising sending a second configuration that indicates one or more second backhaul link transmission opportunities for the second frequency spectrum.

Clause 33: The method of any one of Clauses 22-32, wherein the first configuration comprises an indication to monitor one or more transmission occasions via the first frequency spectrum corresponding to the one or more first backhaul link transmission opportunities.

Clause 34: The method of Clause 33, wherein the first configuration comprises an indication to refrain from translating communications based on one or more radio measurements of the first frequency spectrum satisfying a threshold.

Clause 35: The method of any one of Clauses 22-34, wherein the first configuration comprises an indication to translate communications via a portion of the second frequency spectrum based on one or more radio measurements of the first frequency spectrum satisfying a threshold.

Clause 36: The method of any one of Clauses 22-35, further comprising obtaining a reservation signal in a backhaul link transmission opportunity via the second frequency spectrum when one or more radio measurements of the first frequency spectrum satisfy a threshold.

Clause 37: The method of Clause 36, wherein the first configuration comprises an indication of a transmit power level to use for transmission of the reservation signal.

Clause 38: The method of Clause 36, further comprising obtaining an indication that the reservation signal is being communicated in the backhaul link transmission opportunity.

Clause 39: The method of any one of Clauses 22-38, wherein the first configuration comprises an indication of a transmit power level to use for power amplification for translating the one or more signals.

Clause 40: The method of any one of Clauses 22-39, further comprising sending a second configuration that indicates a set of transmission occasions allocated in the first frequency spectrum, wherein the one or more first backhaul link transmission opportunities correspond to the set of transmission occasions.

Clause 41: The method of any one of Clauses 22-40, further comprising: obtaining a second signal via the first frequency spectrum; and determining a payload of the first signal based on the first signal and the second signal.

Clause 42: One or more apparatuses, comprising: one or more memories comprising executable instructions; and one or more processors configured to execute the executable instructions and cause the one or more apparatuses to perform a method in accordance with any one of Clauses 1-41.

Clause 43: One or more apparatuses, comprising: one or more memories; and one or more processors, coupled to the one or more memories, configured to cause the one or more apparatuses to perform a method in accordance with any one of Clauses 1-41.

Clause 44: One or more apparatuses, comprising: one or more memories; and one or more processors, coupled to the one or more memories, configured to perform a method in accordance with any one of Clauses 1-41.

Clause 45: One or more apparatuses, comprising means for performing a method in accordance with any one of Clauses 1-41.

Clause 46: One or more non-transitory computer-readable media comprising executable instructions that, when executed by one or more processors of one or more apparatuses, cause the one or more apparatuses to perform a method in accordance with any one of Clauses 1-41.

Clause 47: One or more computer program products embodied on one or more computer-readable storage media comprising code for performing a method in accordance with any one of Clauses 1-41.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain a first configuration that indicates one or more first backhaul link transmission opportunities for translating one or more signals from a first frequency spectrum to a second frequency spectrum, wherein the first frequency spectrum is different from the second frequency spectrum; and
send a first signal to one or more network entities via the second frequency spectrum based on a second signal from one or more user equipment (UEs) via the first frequency spectrum.

2. The apparatus of claim 1, wherein:
the one or more processors are configured to cause the apparatus to obtain, from the one or more UEs, the second signal via the first frequency spectrum; and
wherein to send the first signal, the one or more processors are configured to cause the apparatus to convert the second signal in the first frequency spectrum to the first signal in the second frequency spectrum.

3. The apparatus of claim 1, wherein:
the first frequency spectrum is a licensed spectrum; and
the second frequency spectrum is a shared spectrum.

4. The apparatus of claim 1, wherein to send the first signal, the one or more processors are configured to cause the apparatus to send the first signal in at least one backhaul link transmission opportunity of the one or more first backhaul link transmission opportunities.

5. The apparatus of claim 1, wherein the one or more first backhaul link transmission opportunities correspond to a set of transmission occasions allocated in the first frequency spectrum for the one or more UEs.

6. The apparatus of claim 1, wherein the one or more first backhaul link transmission opportunities correspond to one or more transmission occasions of one or more sounding reference signal transmissions from the one or more UEs.

7. The apparatus of claim 1, wherein the first configuration comprises one or more of:
an indication of a channel access procedure to use for communications via the second frequency spectrum;
a channel access priority class associated with at least one backhaul link transmission opportunity of the one or more first backhaul link transmission opportunities; or
an indication of one or more frequency resources to use for communications via the second frequency spectrum.

8. The apparatus of claim 1, wherein:
the one or more processors are configured to cause the apparatus to obtain an indication to activate the one or more first backhaul link transmission opportunities for translating the one or more signals; and
to send the first signal, the one or more processors are configured to cause the apparatus to send the first signal in response to the indication to activate the one or more first backhaul link transmission opportunities.

9. The apparatus of claim 1, wherein the one or more processors are configured to cause the apparatus to deactivate the one or more first backhaul link transmission opportunities.

10. The apparatus of claim 1, wherein the one or more processors are configured to cause the apparatus to obtain a second configuration that indicates one or more second backhaul link transmission opportunities for the second frequency spectrum.

11. The apparatus of claim 1, wherein the first configuration comprises an indication to monitor one or more transmission occasions via the first frequency spectrum corresponding to the one or more first backhaul link transmission opportunities.

12. The apparatus of claim 1, wherein the first configuration comprises an indication to translate communications via a portion of the second frequency spectrum based on one or more radio measurements of the first frequency spectrum satisfying a threshold.

13. The apparatus of claim 1, wherein the one or more processors are configured to cause the apparatus to refrain from sending a transmission in a backhaul link transmission opportunity via the second frequency spectrum when one or more radio measurements of the first frequency spectrum satisfy a threshold.

14. The apparatus of claim 1, wherein the one or more processors are configured to cause the apparatus to send a reservation signal in a backhaul link transmission opportunity via the second frequency spectrum when one or more radio measurements of the first frequency spectrum satisfy a threshold.

15. The apparatus of claim 1, wherein the one or more processors are configured to cause the apparatus to send the first signal with an amplified power level via the second frequency spectrum based on one or more radio measurements of the first frequency spectrum satisfying a threshold.

16. The apparatus of claim 1, wherein the first configuration comprises an indication of a transmit power level to use for power amplification for translating the one or more signals.

17. An apparatus configured for wireless communications, comprising:
one or more memories; and
one or more processors coupled to the one or more memories, the one or more processors being configured to cause the apparatus to:
send a first configuration that indicates one or more first backhaul link transmission opportunities for translating one or more signals from a first frequency spectrum to a second frequency spectrum, wherein the first frequency spectrum is different from the second frequency spectrum; and
obtain a first signal via the second frequency spectrum.

18. The apparatus of claim 17, wherein:
the first frequency spectrum is a licensed spectrum; and
the second frequency spectrum is a shared spectrum.

19. The apparatus of claim 17, wherein the one or more processors are configured to cause the apparatus to send a second configuration that indicates a set of transmission occasions allocated in the first frequency spectrum, wherein the one or more first backhaul link transmission opportunities correspond to the set of transmission occasions.

20. The apparatus of claim 17, wherein the one or more processors are configured to cause the apparatus to:
obtain a second signal via the first frequency spectrum; and
determine a payload of the first signal based on the first signal and the second signal.
